(19) United States
(12) Patent Application Publication
(10) Pub. No.: US 2012/0233122 A1
(43) Pub. Date: Sep. 13, 2012

(54) System and method for session synchronization with independent external systems

(75) Inventors: Cécile Briet, Antibes (FR); Jérôme Mikaelian, Biot (FR); Loïck Pierlot, Garbejaire (FR); Bertrand Alberola, Mouans Sartoux (FR)

(73) Assignee: AMADEUS s.a.s

(21) Appl. No.: 13/135,515

(22) Filed: Jul. 6, 2011

(30) Foreign Application Priority Data
Mar. 10, 2011 (EP) 11305256.7

(51) Int. Cl. G06F 17/30; G06F 15/16

(52) U.S. Cl. 707/634; 707/E17.005

(57) ABSTRACT

A method of providing data synchronization in a data processing architecture including a data store, a client-server or web server system for accessing said data store, and at least one, possibly heterogeneous, external system independent of said data store. A version merge mechanism handles concurrent update of a given user data in said data store occurring when said data are simultaneously modified by the user and by other processes operating on said external systems. A particular feature of said method is that user related data, including data from the external systems, are saved without risk of loss even if the user has started a user session and is still working on it, and user session is not forced to be saved until the user decides so. A system is described, with a system architecture that suits the disclosed method. Several system configurations and typical use scenarios are provided.

### FIELD OF THE INVENTION

The present invention relates in general to data processing systems and in particular to client-server and web server software architectures used for database access. Still more specifically, the present invention relates to a method and a system to optimize data synchronization from independent and possibly heterogeneous external systems, in a transaction operated on a reference system, while minimizing the risk of data loss.

An independent external system is here to be understood as an external system controlled independently of the reference system. The reference system can be controlled by an agent or user, or can be automatic.

A heterogeneous external system is here to be understood as an external system with processes, applications and data structures defined in it that may differ from those of the reference system.

One example of application relates to travel booking and ticketing in the airline industry. The external system can be an automatic mechanism e.g. a robot operated by a global distribution system (GDS) such as Amadeus, a company with headquarters in Madrid, Spain. The automatic mechanism can for instance be arranged for updating records, such as passenger name records (PNR), directly in the store. Updates may consist in automatically cancelling non ticketed bookings.

According to another example, the external system is accessed by a travel agent and allows booking on a system independent of the reference system. The external system may for instance allow booking entertainment events whereas the reference system allows booking travel tickets.

### BACKGROUND OF THE INVENTION

Data synchronization can be defined as the task of keeping data consistent between various components of a system that works on given reference data and duplicates of such data. For that purpose, a version number is usually assigned to each data element. A data element may be defined by a data structure and a unique identifier.

The problem of data synchronization in a multi-user system in a shared data environment is a well known general problem that has been addressed in various contexts that command specific solutions according to system architectures, supported applications and any specific aspects and requirements of such systems.

Most synchronization methods found in the related art rely on a central component that acts as a coordinator between various users, applications, processes or systems that need to work on synchronized data. This is indeed a very generic concept that suggests having a unique manager in charge of the required coordination.

Based on this solution, U.S. Pat. No. 7,539,778 discloses a client-server architecture for synchronization of data between different clients, by deploying a central synchronization server between clients and a Back End data store. A particular method of synchronization is disclosed, based on a cache for permanently buffering incoming updates into a permanent store by assigning a unique cache identifier to each of them. Write conflicts between the synchronization server writing new entries to the cache and updates replicated from backend to cache are solved using a blocking mechanism based on the cache identifiers. This synchronization solution is therefore based on a cache component that performs two tasks: solve write conflicts on updates and minimize the connection and the transport to the Back End data store.

A feature of U.S. Pat. No. 7,539,778 relevant to data synchronization is the handling of write conflicts, using identifiers for cache entries. However, this method does not aim at providing data synchronization in a system based on a data store and other, independent and possibly heterogeneous, external systems.

To deal with the problem of concurrent access to a data store due to a local process and additional processes from independent and possibly heterogeneous external systems, a number of specific issues must be addressed.

For instance, in a transaction processing system such as an electronic commerce platform, there might be a wide range of products and multiple providers of such products. Data relative to products and their providers are usually kept in one storage facility provided in the processing system. However, some of these products might be available in a package containing additional products outsourced from external systems.

Moreover, several users and several transaction applications may access the whole system at the same moment. This is especially true in systems with inherent massive concurrent access such as mass market electronic commerce platforms. Data relative to a transaction session opened by a given user might become obsolete regarding availability, pricing etc. due to product management updates and due to transactions operated by other users and by other applications.

There might be further reasons of data obsolescence such as unexpected events affecting product availability and price, modifications of business policies decided by providers etc.

The resulting problem faced by such a system is summarized in FIG. 1A. The sequence diagram of FIG. 1A illustrates a version conflict between a user dossier in store and user session to save. Some data in the dossier in store have been modified by another application, possibly from an external system, while user A was working on data retrieved from a previous version of said dossier in store. Suppose that user A decides to save his/her work. The data to save are based on an obsolete version of said dossier in store. Such data are likely to be invalid.

In classical transaction processing systems, one may define three types of version handling methods to cope with the problem of version conflict.

A first option is to refuse version conflict. This is a simple and robust method that consists in rejecting any save order if the version of user dossier to be saved by user session does not match the current version of user dossier in store. This policy ensures that there are never any concurrent access issues since the only difference between the dossier in store and the one to be stored is the update resulting from user session. Although this method is very simple to implement and robust, its obvious limitation is that data to save from user session or from any external system may be rejected and user's work could be lost. In case of conflict, the only solution allowed is to ignore the current work, retrieve the new version from store, redo the work and try again to save, hoping that this time the dossier in store was not updated meanwhile. This approach is very aggressive and ineffective in heavy concurrent access business models.

A second option is to handle version conflict in a save everything approach. In current systems using sessions and synchronizing with other systems, there is only one synchronized source of data. Adding data from an external system implies to merge all the data in the session and then decide what to do; this is feasible if and only if the user session can be aware, via signaling means, that some data were made available by an external system. The first possible choice is to save this merged session straight away in the store. This is not a perfect mechanism from a user perspective since there may be some wrong or temporary data in user session, due to user work in progress, and these data will be saved in the dossier in store out of user's control. It allows the session to get an updated view from the store.

Alternatively, a third option is to handle version conflict in a save nothing approach. This means that data from an external system are put in session without being saved, pending user's decision to save. This increases the risk of data loss. If the user finally omits to save, data from an external system may never be retrieved again and would be lost. To simplify this issue, actual systems usually ask the user to save session data before synchronizing with external systems, but this is a strong constraint for the user. A second issue is that new data in the stored user dossier may not become visible to the user.

The relative drawbacks and benefits of the three methods of version conflict handling are summarized in FIG. 1B.

### OBJECT OF THE INVENTION

Thus, it is a broad object of the invention to disclose a method and a system for improving data synchronization in a data processing architecture including a data store, client-server or web server systems for accessing said data store, and a plurality of independent and possibly heterogeneous systems external to said data store.

More specifically, the invention aims at solving a main technical problem related to the retrieval and aggregation of data from independent and possibly heterogeneous external sources in a data store.

It is a further more specific object of the invention that this must fit data processing architectures such as the ones deployed for airlines reservation systems, and characterized by a very high level of transactions from client side and very frequent updates for instance of the fare and availability data bases provided by airlines and of other products and services related to the travel and tourism industry.

Further objects, features and advantages of the present invention will become apparent to the ones skilled in the art upon examination of the following description in reference to the accompanying drawings. It is intended that any additional advantages be incorporated herein.

### SUMMARY OF THE INVENTION

According to a first aspect, the invention provides a method for improving data synchronization in a data processing architecture including a data store, client-server or web server systems for accessing said data store, and a plurality of independent and possibly heterogeneous systems external to said data store.

The invention brings a solution to a main technical problem related to the retrieval and aggregation of data from independent and possibly heterogeneous external sources in a data store.

Additionally, the invention provides a version merge mechanism that improves version conflict management methods found in the prior art. The method of the invention handles concurrent update of a given user data in said data store occurring when said data are simultaneously modified by the user and by other processes operating on said external systems. For that purpose, the invention proposes to define and apply sets of rules to determine which source of information is given priority in case two channels want to update the same data in a dossier at the same time.

This results in removing the risk of data loss caused by version conflict between data retrieved and modified by a user session and an updated version of the stored data not matching the retrieved version. More specifically, an advantage provided by the invention is that user related data, including data from external systems, are saved without risk of loss, even if the user has started a user session and is still working on it.

A further advantage obtained is a way of updating user session with data from the external systems not forcing user data to be saved, thus preventing data not yet validated from being saved.

More specifically, an aspect of the invention relates to a method of providing data synchronization between a session of a user, a data store storing a stored dossier and at least one external system, the method comprising the following steps performed with at least one data processor:
a synchronizer in communication with at least the session and the data store receives a request from the session to retrieve the stored dossier from the data store;
the synchronizer retrieves the stored dossier from the data store, creates from the stored dossier an intermediate dossier comprising at least the content of the stored dossier and delivers the intermediate dossier to the session, as a session dossier, for operations by the user;
receiving external data from the at least one external system,
the synchronizer receives user updates that are performed on the session dossier,
the synchronizer updates the intermediate dossier so that the intermediate dossier comprises said external data,
modifying the stored dossier so that it comprises said external data and saving the stored dossier in the data store,
the synchronizer updates the intermediate dossier through merging said user updates and the intermediate dossier; and then provides the user with the intermediate dossier.

Therefore, the session receives an updated intermediate dossier comprising the data sent by the external system and the latest version stored dossier. Thus, the user is further able to work on an up-to-date version of the intermediate dossier. At this stage, the stored dossier has not been modified by the user. While all data received by external systems are saved in the stored dossier, all changes performed by the session can therefore be further saved in the data store or be deleted without modifying the stored dossier in the data store. Thus, the invention eases significantly the work done by the user by preventing loss of data from external systems without forcing the user to save updates of its session.

The exemplary aspects of this invention also encompass a non-transitory computer-readable medium that contains software program instructions, where execution of the software program instructions by at least one data processor results in performance of operations that comprise execution of the method as described above.

In yet another aspect of this invention there is a system for providing data synchronization comprising a data store, a session comprising a user interface and arranged for accessing a stored dossier stored in said data store and at least an external system, characterized in that it comprises a synchronizer in communication with at least the session and the data store, the system being arranged to perform the following steps with at least one data processor:
the synchronizer receives a request from the session to retrieve the stored dossier from the data store;
the synchronizer retrieves the stored dossier from the data store, creates from the stored dossier an intermediate dossier comprising at least the content of the stored dossier and delivers the intermediate dossier to the session, as a session dossier, for operations by the user;
receiving external data from the external system,
the synchronizer receives user updates that are performed on the session dossier,
the synchronizer updates the intermediate dossier so that the intermediate dossier comprises said external data,
modifying the stored dossier so that it comprises said external data and saving the stored dossier in the data store,
the synchronizer updates the intermediate dossier through merging said user updates and the intermediate dossier; and then provides the user with the intermediate dossier as updated.

Preferably at least an external system is accessible through the session.

Preferably, said external system is independent of said data store.

### BRIEF DESCRIPTION OF THE DRAWINGS

FIG. 1A shows an example of concurrent access in data store.

FIG. 1B discusses relative drawbacks and benefits of existing methods of version conflict handling.

FIG. 2 shows an example of system high-level software architecture to which the invention advantageously applies.

FIG. 3 shows an example of detailed system architecture to which the invention advantageously applies.

FIG. 4 shows an example of detailed system architecture to which the invention advantageously applies, with communication flows for a sequence of typical tasks to be performed.

FIG. 5 provides an example of sequential diagram of the various typical steps that result from the processing of end-user requests and actions from external systems.

FIG. 6 provides an overview of the merge process.

FIG. 7 explains how a set of rules is applied on data intersection between external data and session data, and for two dossiers in general.

FIG. 8 shows an example of detailed system architecture to which the invention advantageously applies, with communication flows for a sequence of typical tasks to be performed in the case of asynchronous event handling enhanced by a scheduled task.

FIG. 9 provides an example of sequential diagram of the various typical steps that result from the processing of end-user requests and actions from external systems in the case of asynchronous event handling enhanced by a scheduled task.

FIG. 10 shows an example of detailed system architecture to which the invention advantageously applies, with communication flows for a sequence of typical tasks to be performed in the case of a store update only.

FIG. 11 provides an example of sequential diagram of the various typical steps that result from the processing of end-user requests and actions from external systems in the case of a store update only.

FIG. 12 shows an example of detailed system architecture to which the invention advantageously applies, with communication flows for a sequence of typical tasks to be performed in the case of an asynchronous update by an external system and no user session.

FIG. 13 provides an example of sequential diagram of the various typical steps that result from the processing of actions from external systems in the case of an asynchronous update by an external system and no user session.

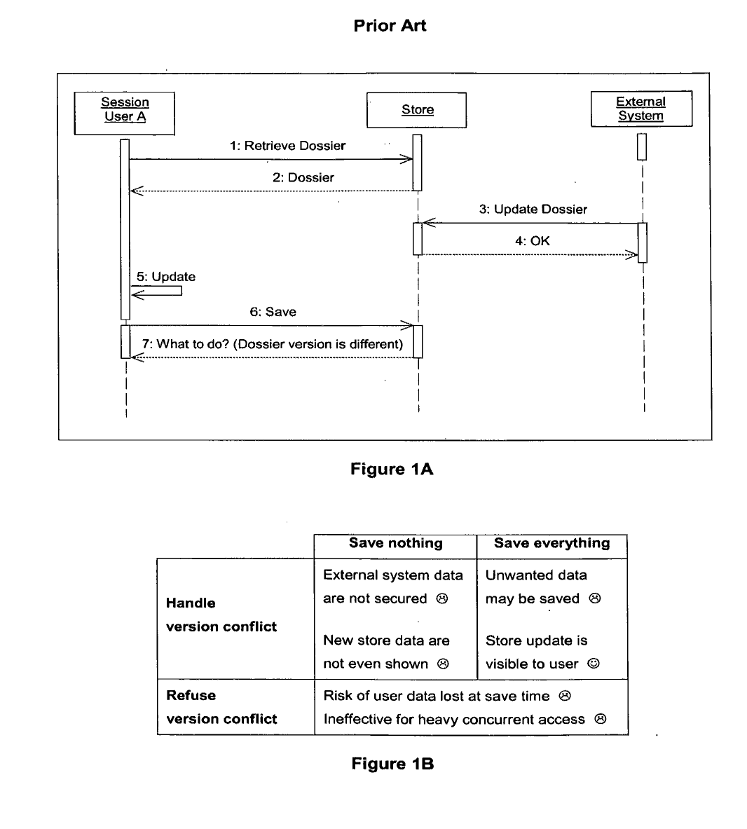

### DETAILED DESCRIPTION

The following detailed description of the invention refers to the accompanying drawings. While the description includes exemplary embodiments, other embodiments are possible, and changes may be made to the embodiments described without departing from the spirit and scope of the invention.

Preliminarily, it is recalled that according to a first aspect, the invention provides a method of providing data synchronization between a session of a user, a data store storing a stored dossier and at least one external system, the method comprising the following steps performed with at least one data processor:
a synchronizer in communication with at least the session and the data store receives a request from the session to retrieve the stored dossier from the data store;
the synchronizer retrieves the stored dossier from the data store, creates from the stored dossier an intermediate dossier comprising at least the content of the stored dossier and delivers the intermediate dossier to the session, as a session dossier, for operations by the user;
receiving external data from the at least one external system,
the synchronizer receives user updates that are performed on the session dossier,
the synchronizer updates the intermediate dossier so that the intermediate dossier comprises said external data,
modifying the stored dossier so that it comprises said external data and saving the stored dossier in the data store,
the synchronizer updates the intermediate dossier through merging said user updates and the intermediate dossier; and then provides the user with the intermediate dossier.

Therefore, the session receives an updated intermediate dossier comprising the data sent by the external system and the latest version stored dossier. Thus, the user is further able to work on an up-to-date version of the intermediate dossier. At this stage, the stored dossier has not been modified by the user. While all data received by external systems are saved in the stored dossier, all changes performed by the session can therefore be further saved in the data store or be deleted without modifying the stored dossier in the data store. Thus, the invention eases significantly the work done by the user by preventing loss of data from external systems without forcing the user to save updates of its session.

The method according to the invention may comprise any one of the following optional features and steps:

In accordance with the first aspect, the external system can be heterogeneous with the data store. This is possible thanks to the merge function performed by the synchronizer.

Further more specifically, upon reception at the synchronizer of a request for refresh sent by the session, the synchronizer:
performs the step wherein it updates the intermediate dossier so that the intermediate dossier comprises said external data;
sends the intermediate dossier to the session to replace the session dossier.

According to an embodiment of the invention, said external data from the external system are received by the data store. Upon reception of said external data by the data store the data store performs the step of modifying the stored dossier so that it comprises said external data and the step of saving the stored dossier in the data store.

Preferably, the step where the synchronizer updates the intermediate dossier so that the intermediate dossier comprises said external data occurs after the steps of modifying the stored dossier so that it comprises said external data and of saving the stored dossier in the data store and comprises the following steps: the synchronizer retrieves the stored dossier from the data store and updates the intermediate dossier with the stored dossier.

Advantageously, the steps of modifying the stored dossier so that it comprises said external data and of saving the stored dossier in the data store occur upon reception of the external data by the data store. After receiving at the synchronizer a request for refresh sent by the session and before the step wherein the synchronizer sends the intermediate dossier to the session to replace the session dossier, then the synchronizer updates the intermediate dossier with the stored dossier.

Further in accordance with the first aspect of this invention, said external data from the external system are received at an event queue in communication with the synchronizer. The step where the synchronizer updates the intermediate dossier so that the intermediate dossier comprises said external data comprises the following steps: the synchronizer retrieves said external data from the event queue, retrieves the stored dossier from the data store, and then updates the intermediate dossier through merging said external data and the stored dossier.

The synchronizer may first retrieves said external data from the event queue and then retrieves the stored dossier from the data store. Alternatively, the synchronizer first retrieves the stored dossier from the data store and then retrieves said external data from the event queue.

Preferably, for performing the steps of modifying the stored dossier so that it comprises said external data and of saving the stored dossier in the data store, the synchronizer saves in the data store the intermediate dossier.

Preferably, the synchronizer then initiates the step wherein the data store saves the intermediate dossier.

Upon reception of said external data from the external system, the event queue sends to said external system a confirmation that said data are correctly received.

After the step of receiving at the synchronizer a request for refresh sent by the session and before the step wherein the synchronizer sends the intermediate dossier to the session to replace the session dossier, the method performs the steps wherein the synchronizer updates the intermediate dossier through merging said external data and the stored dossier.

Further in accordance with the first aspect of this invention, the step of receiving external data from the external system comprises receiving external data by the data store and receiving additional external data by an event queue in communication with the synchronizer. Preferably, upon reception of said external data by the data store then the data store performs the step of modifying the stored dossier so that it comprises said external data and the step of saving the stored dossier in the data store. The synchronizer retrieves said additional external data from the event queue, retrieves the stored dossier from the data store, updates the intermediate dossier through merging said additional external data and the stored dossier and replaces the stored dossier with the intermediate dossier.

Thus, at this stage, the stored dossier and the intermediate dossier comprise the external data received at the data store and the additional external data received at the event queue.

Then the synchronizer can update the intermediate dossier through merging said user updates and the intermediate dossier for providing the user with an intermediate dossier comprising the external data received at the data store, the additional external data received at the event queue and the user updates.

Upon the update of the intermediate dossier by the synchronizer through merging said additional external data and the stored dossier, the synchronizer saves in the data store the intermediate dossier. Thus, at this stage, the stored dossier comprises the external data received at the data store and the additional external data received at the event queue.

In all embodiments, the step of receiving external data by the data store can occur before or after the step of receiving additional external data by an event queue.

The synchronizer receives from the session additional user updates, then the synchronizer retrieves the stored dossier from the data store, updates the intermediate dossier through merging the stored dossier with the additional user updates from the session and sends the intermediate dossier to the session to replace the session dossier.

Preferably, the session provides the user with a possibility to save the intermediate dossier in the data store. Thus, the session provides the user with a possibility to update the intermediate dossier through merging external data received from the external system, the stored dossier and the session dossier, and then to save the intermediate dossier as updated in the data store. Therefore, the work possibly performed by the user through the session and all data possibly received from the at least one external system are saved in the data store. Thus, next time the synchronizer retrieves the stored dossier, that retrieved version will comprise updates from the session and data from the at least one external system.

According to a preferred embodiment, the possibility is a question asked to the user through a user interface of the session about saving or not saving the session dossier, said question being asked when the session receives an instruction to close the session.

The session receives an instruction for saving the session dossier and sends to the synchronizer a save request, wherein upon reception of the save request the synchronizer updates the intermediate dossier through merging data received from the external system, the stored dossier and the session dossier, and saves the intermediate dossier as updated in the data store.

Alternatively, if the session does not receive instruction to save the session dossier or if the session receives an instruction to delete the session dossier, then the user updates are not saved and the session does not update the stored dossier in the data store.

According to a specific embodiment, at least an external system is accessed by the user and at least some of the external data are generated by the user.

According to a specific embodiment, the user accesses the session and at least the external system through the same processing device. Further additionally, said processing device is a personal computer, a smart phone or a personal digital assistant.

According to a specific embodiment, the user accesses the external system through a user interface of the external system. Said external data are sent from the external system to an event queue in communication with the synchronizer when the user switches back from the user interface of the external system to a user interface of the session.

According to a specific embodiment, the user accesses the external system through a user interface of the external system. Said external data are sent from the external system to the data store when the user switches back from the user interface of the external system to a user interface of the session.

According to a specific embodiment, before the synchronizer retrieves the stored dossier from the data store for creating or updating the intermediate dossier, at least one additional external system sends additional external data to the data store, said additional external data updating the stored dossier and being therefore available for subsequent retrieval of the stored dossier by the synchronizer when creating or updating the intermediate dossier.

Preferably, the method comprising a step of identifying in the stored dossier intersection zones that can be modified with data or updates from various sources, said sources being user session or the at least one external system and comprising a step of defining priority rules for each intersection zone.

Thus, if a zone of the stored dossier can be modified with external data from more than one external system or if the stored dossier can be modified with external data from at least one external system plus from the user session, then said zone is identified as an intersection zone.

Preferably, said identification is performed at system configuration time or when a new external system is integrated in the architecture.

If external data or user updates comprise data related to a same intersection zone, then the method applies the priority rules defined for said zone.

Preferably, the step of modifying the stored dossier so that it comprises said external data comprises a step of identifying whether an intersection zone of the stored dossier is impacted by the external data. If so, then applying the priority rules defined for said zone.

Similarly, the step of saving the intermediate dossier in the data store after a merge with the user updates comprises a step of identifying whether an intersection zone of the stored dossier is impacted by the user updates. If so, then applying the priority rules defined for said zone.

According to a specific embodiment, the external system and the additional external system are the same.

According to a specific embodiment, the external system automatically updates the data store without being manually triggered.

The external system is triggered by the user of the session.

When the data store receives the additional data from the additional external system, the data store sends to the additional external system a confirmation that said additional data are correctly received.

Thus, when the synchronizer retrieves the stored dossier from the data store, all additional data sent by the additional external system are taken into account. Therefore, the synchronizer creates or updates the intermediate dossier through merging data from the external system, if any, and the stored dossier that comprises the additional data from the additional external system.

If the synchronizer does not receive updates from the session to be merged with the intermediate dossier and saved and if the event queue does not receive data from the external system, then the stored user dossier is updated by the at least one external system without any interaction with the intermediate dossier and the session dossier.

Preferably, in this case, data from the external system and sent to the event queue are generated by the user accessing the external system while data from the additional external system and sent to the data store are generated independently of the user.

Further additionally, the invention provides a method wherein the additional external system is independent of the data store.

Preferably, the additional external system is independent of the session. Preferably, the additional external system is heterogeneous with the data store. Typically, the additional external system is another session that is controlled by another user/system.

Typically, the data store is an e-ticket data store or an inventory data store which tracks availability related to a transportation service such as availability of flights.

According to a specific embodiment the data store comprises passenger name records (PNR). External data from the external system relate to passenger name records. According to another specific embodiment user updates from the session relate to passenger name records.

Typically, the session provides a reservation system related to the travel and tourism industry. For instance, it can be an airline reservation system, a railway reservation system, etc. and it can be provided by a GDS.

The external system provides additional services or products. For instance, it can be a reservation system for leisure activities such as a safari, an excursion, an exposition visit, a restaurant, a concert, etc. It may also provide hotel reservation.

The external system may also provide transportation services other than the transportation services of the session. For instance, the external system may provide a transportation service regarding a transportation mode similar to the one of the session but with another provider or for another route. Typically, the session and the external system provide flights operated by two different airlines.

The external system may also provide a transportation mode different of the one of the session. Typically, the session provides flight tickets and the external system provides train tickets, ferry tickets or car rental.

Further additionally, in a specific embodiment, the method of invention can be operated through a computer program product stored in a computer-readable memory medium and adapted to perform the method according to any one of the preceding claims.

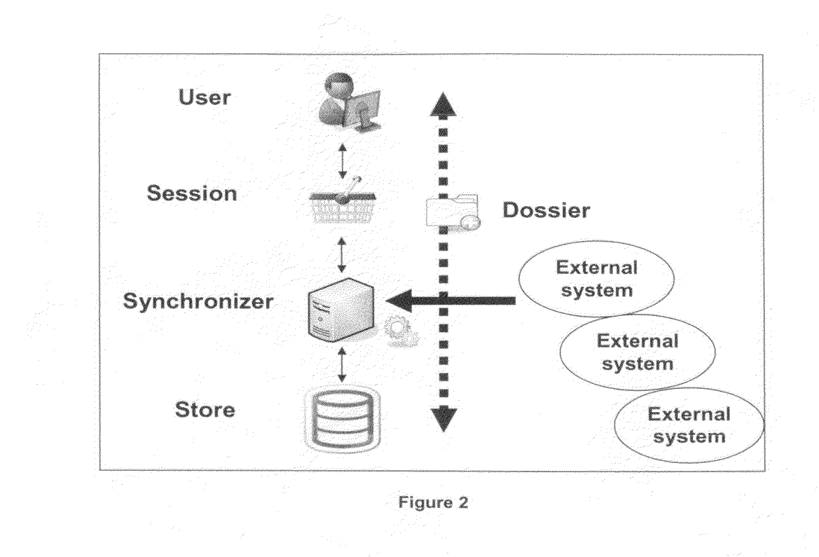

FIG. 2 shows an example of high-level system architecture of the present invention, in which a synchronizer 4 component is located between a data store 1 and a user session 3 and receives data from at least an external systems 5, 5′. The function of this synchronizer 4 is to aggregate and merge data. For any dossier retrieved from data store 1 for a given user session 3, and to receive updates from at least an external system 5, 5′ and from user session 3, the synchronizer 4 creates or updates an intermediate dossier. The intermediate dossier can be updated by merging the current intermediate dossier with the session dossier and with dossier updates received from external systems if such updates are available. The synchronizer 4 updates the intermediate dossier according to a predefined set of rules or by prompting the user whenever necessary.

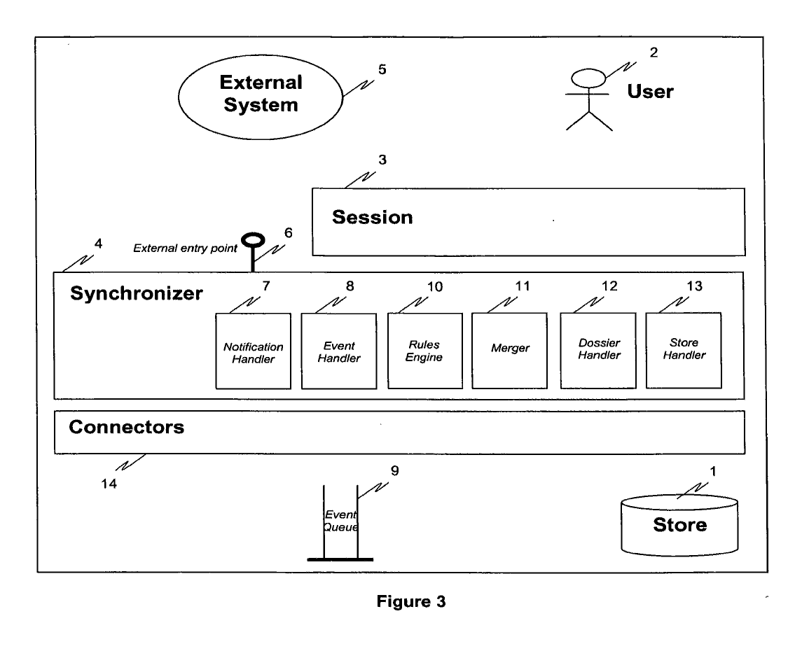

FIG. 3 shows an example of detailed system architecture to which the invention advantageously applies. This architecture will be used to illustrate different scenarios of interest and, for that purpose, the communication flows for each one of such scenarios will be detailed. Accordingly, all elements shown in FIG. 3 are described in subsequent figures related to scenarios of interest.

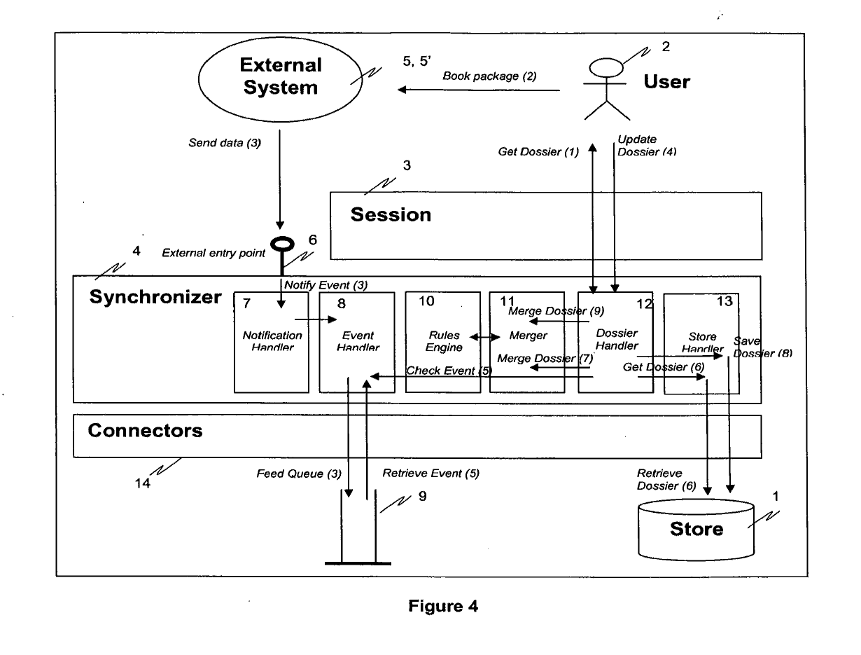

FIG. 4 shows an example of detailed system architecture to which the invention advantageously applies. A sequence of typical tasks to be performed by the system and related communication flows are also shown. This sequence corresponds to the following scenario:

At step 1, a user 2 is working in a user session 3 and for that matter a user dossier is retrieved from data store 1 and displayed. For that step, the stored dossier is firstly retrieved from data store 1 by the synchronizer 4, as an intermediate dossier. The intermediate dossier is then sent to user session 3 as a session dossier. This is done through a dossier handler 12 and a store handler 13. The store handler is in charge of retrieving stored dossiers from data store 1 and saving updated dossiers into data store 1. The dossier handler is in charge of receiving requests and updates from user session 3, sending the intermediate dossier to user session 3 and managing all internal tasks of the synchronizer 4 related to the retrieval and save of the intermediate dossier, and to update-merge operations.

At step 2, in order to do a transaction that operates on an external system 5′, such as booking a package, the user switches to that external system 5′, e.g. by opening a tab provided in the user interface, and performs the transaction.

At step 3, the external system 5′ sends the data corresponding to the transaction and the reference to the current dossier to an external entry point 6. The external entry point can be any suitable channel connecting the external system 5′ and the synchronizer 4. It can be provided by a web service or any specific means. The data sent by the external system 5′ are stored temporarily in an event queue 9 through a notification handler 7 and an event handler 8. The event queue 9 is a facility that holds data sent by external systems. The notification handler is a facility in charge of receiving notifications from external systems. The event handler is a facility in charge of handling events, which include such tasks as: to put events in the queue, to retrieve events, to find events to retrieve for a given dossier . . .

At step 4, the user triggers any action, such as switch to dossier tab in the user interface, save dossier, update dossier . . . , which refreshes the session dossier. For that purpose, the intermediate dossier is updated and returned to user session 3. This is done at steps 5 to 9.

At step 5, the synchronizer 4 checks the event queue 9 for any event to be processed for the current dossier. All events in queue are retrieved.

At step 6, the synchronizer 4 retrieves the latest dossier saved in data store 1.

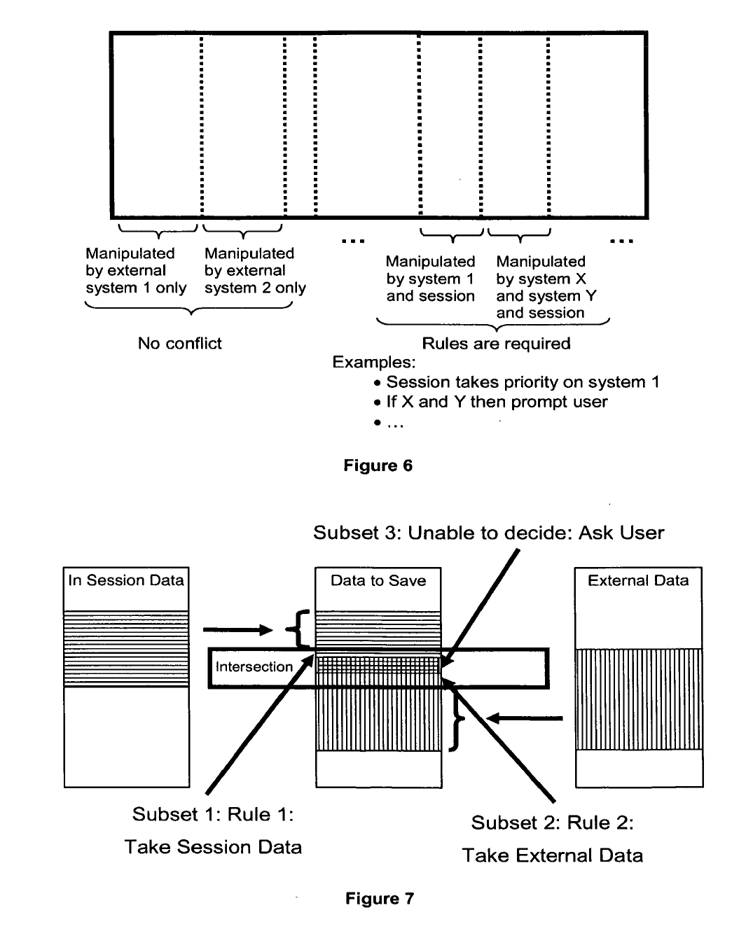

At step 7, the synchronizer 4 merges the latest dossier with the updates from all the events previously retrieved. This is done by a merger 11 with rules supplied by a rules engine 10. The function performed by the merger will be explained in the description of FIG. 6. The function performed by the rules engine will be explained in the description of FIG. 7.

At step 8, the synchronizer 4 saves the merged dossier in data store 1 to avoid data loss.

At step 9, the synchronizer 4 merges the merged dossier with the session dossier and returns the result to the user. This is the dossier displayed to the user.

After step 9, the user may continue to work and, upon completion of the process according to what the session is for, the user may save the dossier for final validation of the transaction; or even before completing the process, the user may save the dossier and rework on it later. Therefore, the session would continue by redoing the previous steps from step 2 or from step 4, until the session dossier is finally saved, or until the user decides to close the session without saving any changes.

Therefore, the invention provides a method of data aggregation particularly suited to a transaction oriented system comprising a main system and other, independent and possibly heterogeneous, external systems.

That method is based on a system architecture and a merge function that improve the methods already known.

The merge function relies on a mechanism that removes the risk of data loss caused by version conflict between data retrieved and modified in user session 3 and an updated version of the stored data not matching the retrieved version.

More specifically, user related data, including data from external systems, are saved without risk of loss even if the user has started a user session 3 and is still working on it.

A further advantage of the method is a way of updating user session 3 with data from the external sources not forcing user data to be saved, thus preventing data not yet validated from being saved.

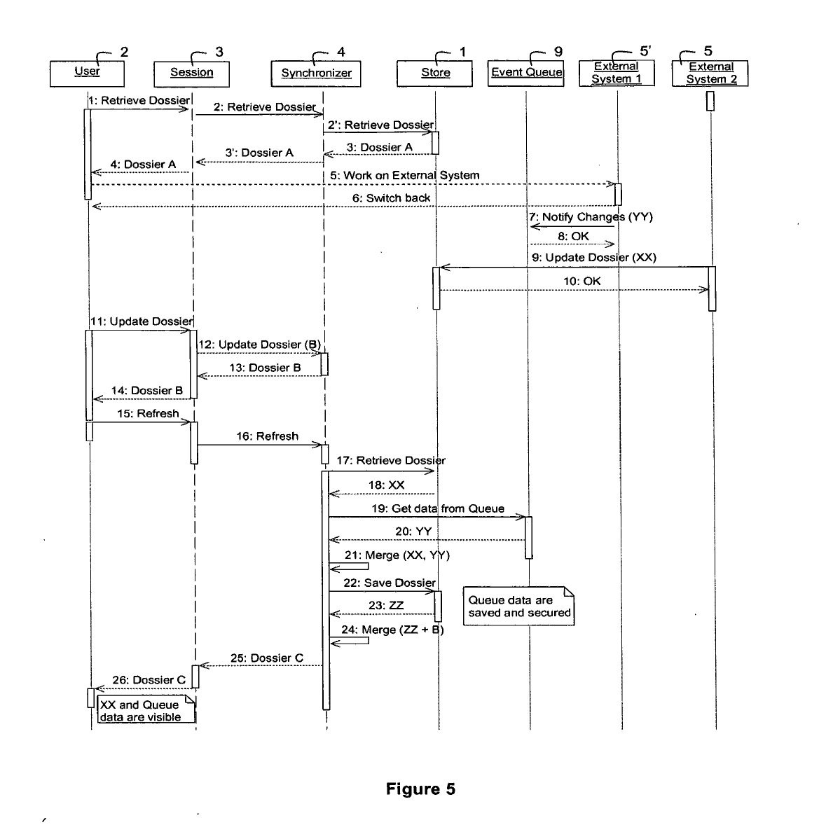

FIG. 5 provides an example of sequential diagram showing the various steps that result from the processing of end user requests and notifications from external systems 5, 5′ in a typical scenario. Note that, in this diagram, the notification received from the external system 5′ might be triggered by the user, for instance when the user switches to that external system and performs an action that cause that external system to send data to the intermediate dossier.

At steps 1, 2, 2′, 3, 3′, 4, a user is working in a user session 3 and for that matter a user dossier is retrieved from data store 1 and displayed. For that, the stored dossier is firstly retrieved from data store 1 by the synchronizer 4, as an intermediate dossier. The intermediate dossier is then sent to user session 3 as a session dossier.

At steps 5, 6, in order to do a transaction that operates on an external system 5′, such as booking a package, the user switches to that external system 5′, e.g. by opening a tab provided in the user interface, performs the transaction and switches back to the opened session.

As a result, an event will be sent to the queue. This is the important fact here.

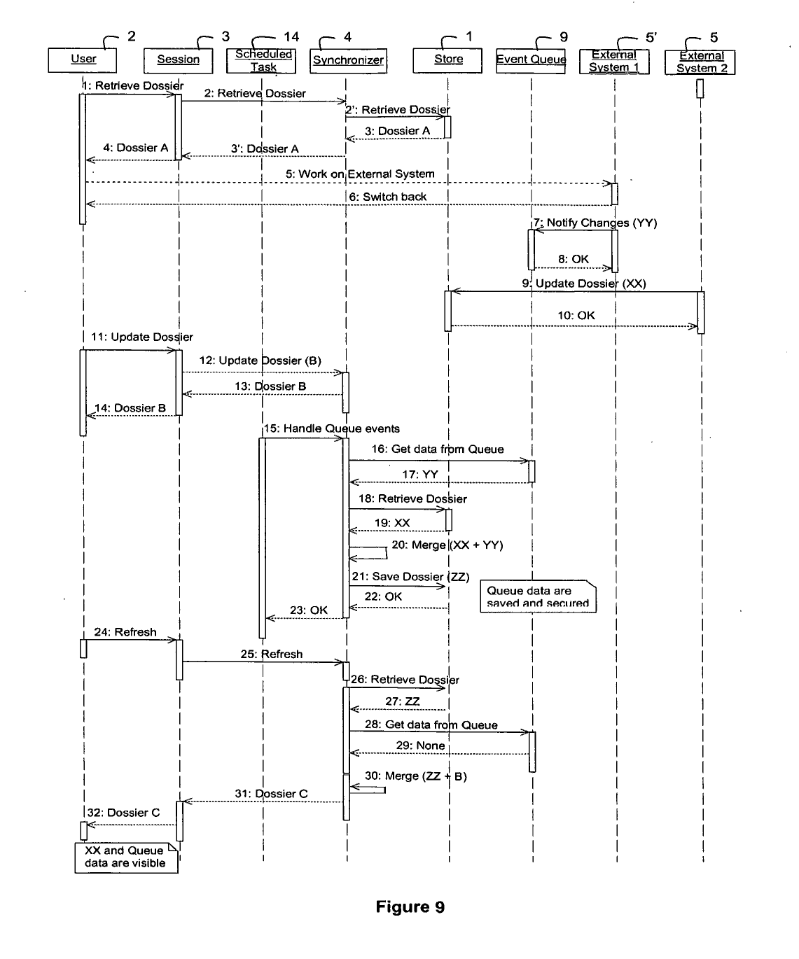

Actually, the update from the external system 5′ may be triggered by the user switching to that external system 5′ or by any independent internal process of the external system. Thus steps 5 and 6 relate to a particular embodiment and do not restrict the scope of the invention. Steps 5 and 6 are then only optional and are illustrated with dotted lines. This also applies to FIG. 9.

At steps 7, 8, the external system 5′ sends a notification of changes related to data in the user dossier. At the synchronizer 4, the data sent by the external system 5′ are stored temporarily in the event queue 9 through the notification handler and the event handler.

At steps 9, 10, an external system 5 directly updates user dossier in data store 1.

At steps 11, 12, 13, 14, user session 3 is updated due to the user working.

At steps 15, 16, the user triggers a refresh of user session 3.

At steps 17, 18, to start refreshing user session 3, the synchronizer 4 retrieves the latest dossier saved in data store 1.

At steps 19, 20, the synchronizer 4 checks the event queue 9 for any event to be processed for the current dossier. All events in queue are retrieved.

At steps 21, the synchronizer 4 merges the latest dossier with the updates from all the events previously retrieved.

At steps 22, 23, the synchronizer 4 saves the merged dossier in data store 1 to avoid data loss. At this point, the updates made by external systems 5, 5′ have been saved and secured.

At steps 24, the synchronizer 4 merges the merged dossier with the session dossier.

At steps 25, 26, the synchronizer 4 returns the result to the user. This is the dossier displayed to the user. Therefore the user now works on a refreshed session synchronized with the updated stored dossier.

Thus, the invention provides a solution to the technical problem related to the retrieval and aggregation of data from independent and possibly heterogeneous external sources in a data store 1.

The invention also allows dealing with the risk of data loss caused by version conflict between stored data retrieved by a user session 3 and an updated version of the stored data not matching the retrieved version.

The method according to the invention also enables to receive and merge data from external sources without forcing user temporary data to be saved.

FIG. 6 provides an overview of the merge process. The version merge mechanism of the invention aims specifically at avoiding a risk of data loss caused by version conflict between data retrieved and modified in user session 3 and an updated version of the stored data not matching the retrieved version. The principle of the method of the invention is to immediately merge and save data received from external systems 5, 5′ and merge and save data from user session 3 only upon request by user session 3. The merge process requires identifying data intersections and applying priority rules to data intersections. This is a two stage process, carried out as follows.

The first stage of the merge process is to identify the zones of intersection between data that are exchanged by the data store 1 and the external systems 5, 5′. This is preferably done at system configuration time, i.e. each time a new external system is integrated in the architecture. The data to integrate are defined and in turn intersections are defined. Then priority rules are defined and configured for run time usage.

The second stage is the run time stage of the merge process. At run time the system checks if there are data in the intersection zone of the exchanged data. If there are, the rules for each attribute in the intersection zone are applied following the configuration.

FIG. 7 explains how a set of rules is applied on data intersection between external data and session data, and for two dossiers in general. This is how rules are applied for a given data intersection at run time.

Three subsets have been identified in the intersection between data in session and external data. A set of rules has been defined, which provides a rule for each subset. Two rules automatically assign a preferred source to the first and second target subsets. There is no automatic rule for the third subset. This subset is dealt with by prompting the user.

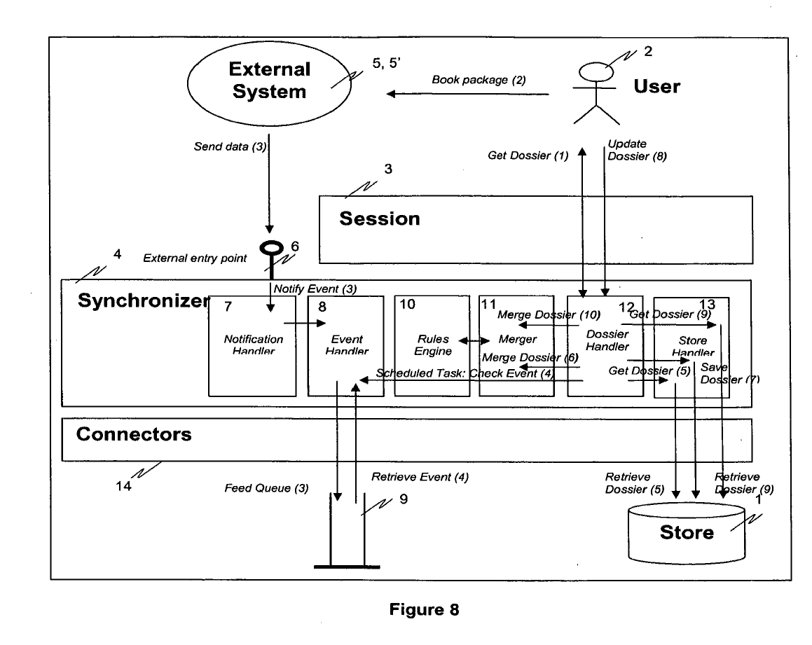

FIG. 8 shows an example of detailed system architecture to which the invention advantageously applies, with communication flows for a sequence of typical tasks to be performed in the case of asynchronous event handling enhanced by a scheduled task 14.

Steps 1 to 3 are identical to steps 1 to 3 of FIG. 4.

At step 4, a scheduled task 14, independent from any session, requests the synchronizer 4 to check the event queue 9 for any event to be processed for the current dossier. All events in queue, if any, are retrieved.

Steps 5 to 7 are identical to steps 6 to 8 of FIG. 4.

Step 8 is identical to step 4 of FIG. 4.

Step 9 is identical to step 6 of FIG. 4.

Step 10 is identical to step 9 of FIG. 4.

Thus, a further advantage of the invention is the possibility for external systems 5, 5′ to notify and send updates to the main system via asynchronous communication.

FIG. 9 provides an example of sequential diagram of the various typical steps that result from the processing of end-user requests and actions from external systems 5, 5′ in the case of asynchronous event handling enhanced by a scheduled task 14. This sequential diagram relates to the scenario and communication flows illustrated by FIG. 8.

Steps 1 to 14 are identical to steps 1 to 14 of FIG. 5.

At step 15, a scheduled task 14, independent from any session, requests the synchronizer 4 to check the event queue 9 for any event to be processed for the current dossier.

At steps 16, 17, all events in queue, if any, are retrieved.

Steps 18, 19 are identical to steps 17, 18 of FIG. 5.

Steps 20, 21, 22 are identical to steps 21, 22, 23 of FIG. 5.

At step 23, the synchronizer 4 has completed the scheduled task 14 and the scheduled task 14 is closed.

Steps 24 to 29 are identical to steps 15 to 20 of FIG. 5. After step 29, since there was no more data in queue, the synchronizer 4 only has to merge session data with the stored dossier just retrieved.

Steps 30 to 32 are identical to steps 24 to 26 of FIG. 5.

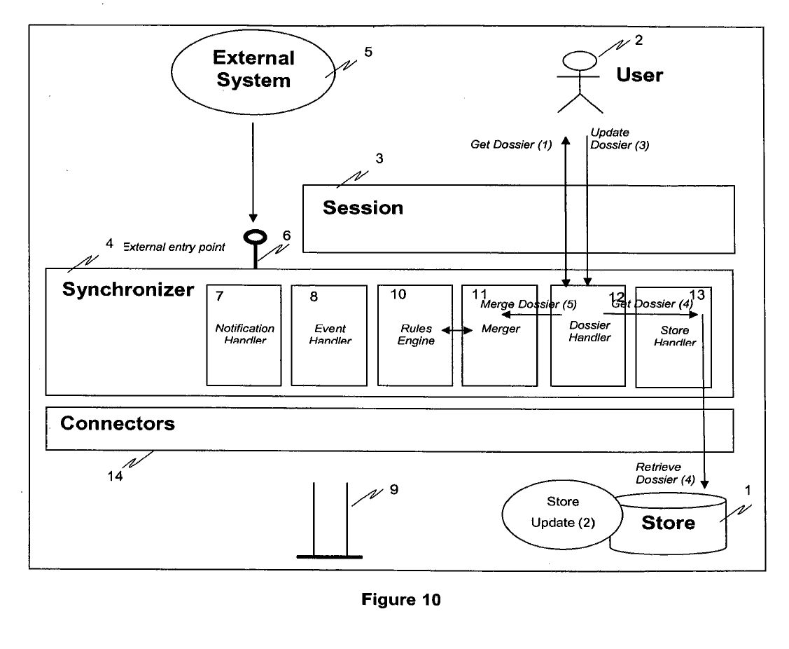

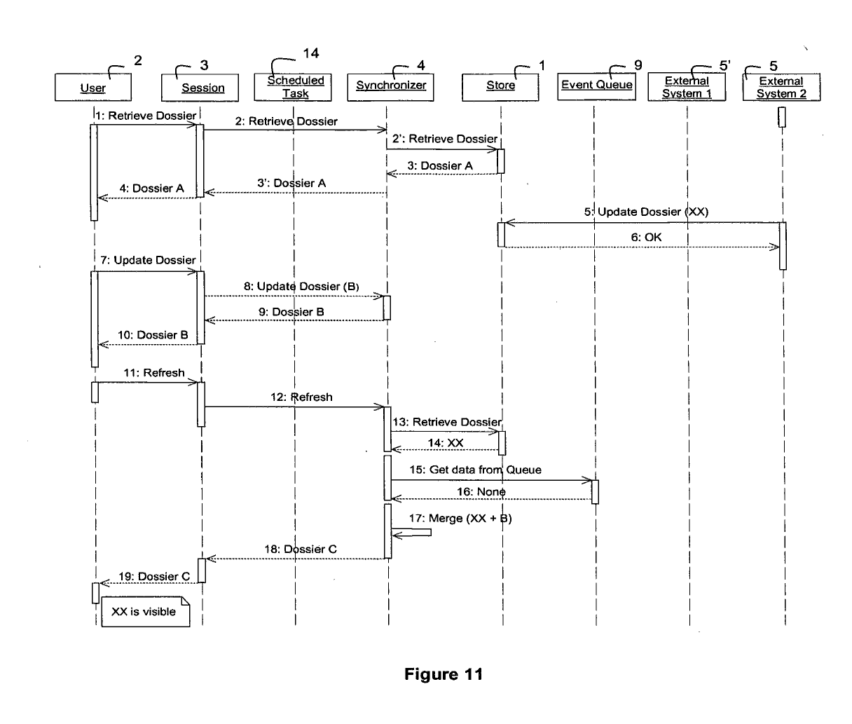

FIG. 10 shows an example of detailed system architecture to which the invention advantageously applies, with communication flows for a sequence of typical tasks to be performed in the case of a store update only.

Step 1 is identical to step 1 of FIG. 4.

At step 2, independently from the intermediate dossier, the stored dossier is updated directly in the data store 1.

Step 3 is identical to step 4 of FIG. 4.

Step 4 is identical to step 6 of FIG. 4.

Step 5 is identical to step 9 of FIG. 4.

Thus, a further advantage of the invention is the possibility for external systems 5 to directly send updates to the main system, i.e. without notification of it to the synchronizer 4 and without forcing user session 3 to be saved. The update will be become visible when user session 3 is refreshed.

FIG. 11 provides an example of sequential diagram of the various typical steps that result from the processing of end-user requests and actions from external systems 5 in the case of a store update only. This sequential diagram relates to the scenario and communication flows illustrated by FIG. 10.

Steps 1 to 4 are identical to steps 1 to 4 of FIG. 5.

Steps 5, 6 are identical to steps 9, 10 of FIG. 5.

Steps 7 to 10 are identical to steps 11 to 14 of FIG. 5.

Steps 11 to 16 are identical to steps 15 to 20 of FIG. 5.

At next step, since there was no data in the event queue 9, the synchronizer 4 only has to merge session data with the stored dossier just retrieved.

Steps 17 to 19 are identical to steps 22 to 24 of FIG. 5.

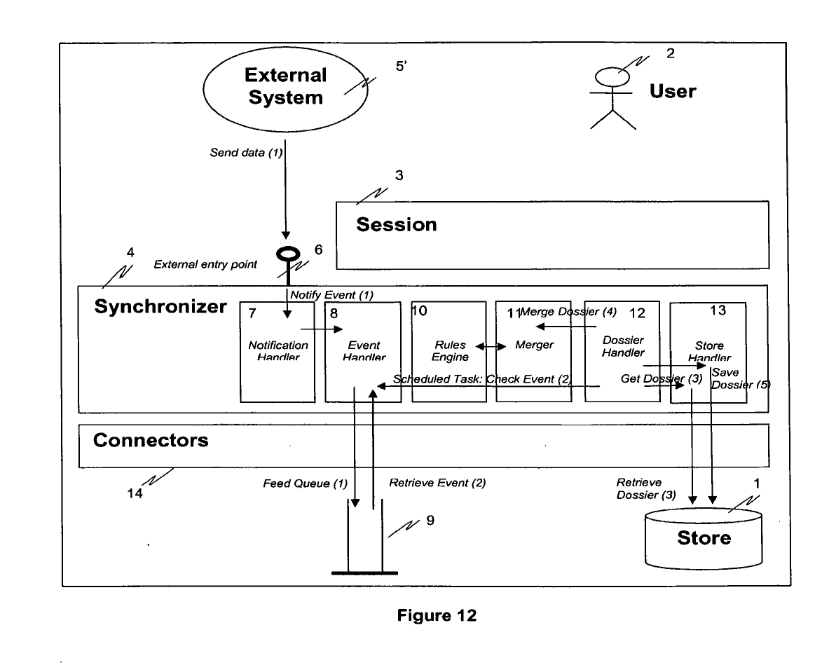

FIG. 12 shows an example of detailed system architecture to which the invention advantageously applies, with communication flows for a sequence of typical tasks to be performed in the case of an asynchronous update by an external system and no user session 3.

At step 1, the data corresponding to a transaction are updated in an external system. The external system sends the data corresponding to the transaction and the reference to the corresponding dossier to the external entry point. The data sent by the external system are stored temporarily in the event queue 9 through the notification handler and the event handler.

Step 2 is identical to step 4 of FIG. 8.

Steps 3 to 5 are identical to steps 5 to 7 of FIG. 8.

FIG. 12 shows that, even if there is no active user session 3, synchronization with an external system can be done via a scheduled task 14.

Thus, a further advantage of the invention is the possibility for external systems 5′ to notify and send updates to the main system and update a given user dossier at any time, whether there is an active user session 3 or there is not. Therefore, data from external systems 5′ are automatically saved in the stored dossier.

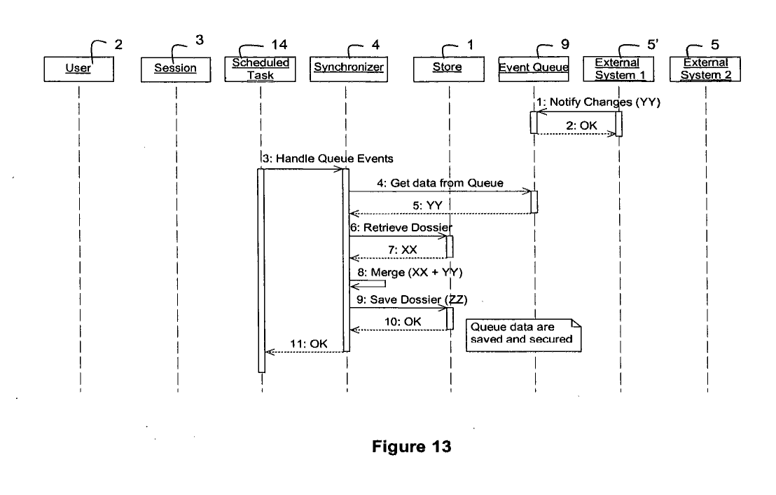

FIG. 13 provides an example of sequential diagram of the various typical steps that result from the processing of end-user requests and actions from external systems 5′ in the case of an asynchronous update by an external system and no user session 3. This sequential diagram relates to the scenario and communication flows illustrated by FIG. 12.

Steps 1, 2 are identical to steps 7, 8 of FIG. 9.

Steps 3 to 11 are identical to steps 15 to 23 of FIG. 9.

Thus, the disclosed invention provides a solution to secure data received from external systems and avoid saving unwanted data such as non validated session data, while allowing store updates to be visible to the user.

1. A method of providing data synchronization between a session of a user, a data store storing a stored dossier and at least one external system, characterized in that it comprises the following steps performed with at least one data processor:
a synchronizer in communication with at least the session and the data store receives a request from the session to retrieve the stored dossier from the data store;
the synchronizer retrieves the stored dossier from the data store, creates from the stored dossier an intermediate dossier comprising at least the content of the stored dossier and delivers the intermediate dossier to the session, as a session dossier, for operations by the user;
receiving external data from the at least one external system,
the synchronizer receives user updates that are performed on the session dossier,
the synchronizer updates the intermediate dossier so that the intermediate dossier comprises said external data,
modifying the stored dossier so that it comprises said external data and saving the stored dossier in the data store,
the synchronizer updates the intermediate dossier through merging said user updates and the intermediate dossier; and then provides the user with the intermediate dossier.

2. The method according to claim 1 wherein upon reception at the synchronizer of a request for refresh sent by the session, the synchronizer:
performs the step wherein it updates the intermediate dossier so that the intermediate dossier comprises said external data;
sends the intermediate dossier to the session to replace the session dossier.

3. The method according to claim 1 wherein said external data from the external system are received by the data store, wherein upon reception of said external data by the data store then the data store performs the step of modifying the stored dossier so that it comprises said external data and the step of saving the stored dossier in the data store.

4. The method according to claim 3 wherein the step where the synchronizer updates the intermediate dossier so that the intermediate dossier comprises said external data occurs after the steps of modifying the stored dossier so that it comprises said external data and of saving the stored dossier in the data store and comprises the following steps: the synchronizer retrieves the stored dossier from the data store and updates the intermediate dossier with the stored dossier.

5. The method according to claim 1 wherein said external data from the external system are received at an event queue in communication with the synchronizer and wherein the step where the synchronizer updates the intermediate dossier so that the intermediate dossier comprises said external data comprises the following steps: the synchronizer retrieves said external data from the event queue, retrieves the stored dossier from the data store, and then updates the intermediate dossier through merging said external data and the stored dossier.

6. The method according to claim 5 wherein for performing the steps of modifying the stored dossier so that it comprises said external data and of saving the stored dossier in the data store, the synchronizer saves in the data store the intermediate dossier.

7. The method according to claim 1 wherein the step of receiving external data from the external system comprises receiving external data by the data store and receiving additional external data by an event queue in communication with the synchronizer.

8. The method according to claim 7 wherein upon reception of said external data by the data store then the data store performs the step of modifying the stored dossier so that it comprises said external data and the step of saving the stored dossier in the data store and wherein the synchronizer retrieves said additional external data from the event queue, retrieves the stored dossier from the data store, updates the intermediate dossier through merging said additional external data and the stored dossier.

9. The method according to claim 8 wherein upon the update of the intermediate dossier by the synchronizer through merging said additional external data and the stored dossier, the synchronizer saves in the data store the intermediate dossier.

10. The method according to claim 1 wherein the synchronizer receives from the session additional user updates, then the synchronizer retrieves the stored dossier from the data store, updates the intermediate dossier through merging the stored dossier with the additional user updates from the session and sends the intermediate dossier to the session to replace the session dossier.

11. The method according to claim 1 wherein the session provides the user with a possibility to save the intermediate dossier in the data store.

12. The method according to claim 11 wherein the possibility is a question asked to the user through a user interface of the session about saving or not saving the session dossier, said question being asked when the session receives an instruction to close the session.

13. The method according to claim 1 wherein the session receives an instruction for saving the session dossier and sends to the synchronizer a save request, wherein upon reception of the save request the synchronizer updates the intermediate dossier through merging data received from the external system, the stored dossier and the session dossier, and saves the intermediate dossier as updated in the data store.

14. The method according to claim 1 wherein if the session does not receive instruction to save the session dossier or if the session receives an instruction to delete the session dossier, then the user updates are not saved and the session does not update the stored dossier in the data store.

15. The method according to claim 1 wherein at least an external system is accessed by the user and at least some of the external data are generated by the user.

16. The method according to claim 1 wherein the user accesses the session and at least the external system through the same processing device.

17. The method according to claim 1 wherein the user accesses the external system through a user interface of the external system and wherein said external data of the external system are sent from the external system to an event queue in communication with the synchronizer when the user switches back from the user interface of the external system to a user interface of the session.

18. The method according to claim 1 wherein the user accesses the external system through a user interface of the external system and wherein said external data of the external system are sent from the external system to the data store when the user switches back from the user interface of the external system to a user interface of the session.

19. The method according to claim 1 wherein before the synchronizer retrieves the stored dossier from the data store for creating or updating the intermediate dossier, at least one additional external system sends additional external data to the data store, said additional external data updating the stored dossier and being therefore available for subsequent retrieval of the stored dossier by the synchronizer when creating or updating the intermediate dossier.

20. The method according to claim 1 comprising a step of identifying in the stored dossier intersection zones that can be modified with data or updates from various sources, said sources being user session or the at least one external system and comprising a step of defining priority rules for each intersection zone.

21. The method according to claim 20 wherein if external data or user updates comprise data related to an intersection zone, then applying the priority rules defined for said zone.

22. The method according to claim 21 wherein the additional external system is independent of the data store.

23. The method according to claim 21 wherein the external system and the additional external system are the same.

24. The method according to claim 1 wherein the session allows booking travel and tourism related services and products or services and products related to the leisure and entertainment industry or to services and products related to art and culture.

25. The method according to claim 1 wherein the session allows booking related to air, train, cruise, car rental, hotel rooms.

26. The method according to claim 1 wherein the external system is at least part of a reservation system or of a global distribution system.

27. The method according to claim 1 wherein the external system automatically updates the data store without being manually triggered.

28. The method according to claim 1 wherein the external system is triggered by the user of the session.

29. The method according to claim 1 wherein the data store comprises passenger name records (PNR).

30. The method according to claim 29 wherein external data from the external system relate to passenger name records.

31. The method according to claim 30 wherein user updates from the session relate to passenger name records.

32. Computer program product stored in a non-transitory computer-readable memory medium and performing the method according to claim 1.

33. System for providing data synchronization comprising a data store, a session comprising a user interface and arranged for accessing a stored dossier stored in said data store and at least an external system characterized in that it comprises a synchronizer in communication with at least the session and the data store, the system being characterized in that it is arranged to perform the following steps with at least one data processor:
the synchronizer receives a request from the session to retrieve the stored dossier from the data store;
the synchronizer retrieves the stored dossier from the data store, creates from the stored dossier an intermediate dossier comprising at least the content of the stored dossier and delivers the intermediate dossier to the session, as a session dossier, for operations by the user;
receiving external data from the external system,
the synchronizer receives user updates that are performed on the session dossier,
the synchronizer updates the intermediate dossier so that the intermediate dossier comprises said external data,
modifying the stored dossier so that it comprises said external data and saving the stored dossier in the data store,
the synchronizer updates the intermediate dossier through merging said user updates and the intermediate dossier; and then provides the user with the intermediate dossier as updated.

34. The system according to claim 33 wherein at least an external system is accessible through the session.

35. The system according to claim 34 wherein said external system is independent of said data store.
